(19) United States
(12) Patent Application Publication
(10) Pub. No.: US 2026/0175498 A1
(43) Pub. Date: Jun. 25, 2026

(54) Molding Management System

(71) Applicant: SEIKO EPSON CORPORATION, Tokyo (JP)

(72) Inventors: Yusuke MITSUMA, SHIOJIRI-SHI (JP); Tomohiro TAKIZAWA, MATSUMOTO-SHI (JP)

(21) Appl. No.: 19/426,933

(22) Filed: Dec. 19, 2025

(30) Foreign Application Priority Data
Dec. 24, 2024 (JP) 2024-227101

(51) Int. Cl. B29C 45/76

(52) U.S. Cl. CPC B29C 45/76; B29C 2045/7606; B29C 2945/76083; B29C 2945/7618

(57) ABSTRACT

A molding management system for managing production of a product performed by an injection molding apparatus, includes an information processing device, the injection molding apparatus includes an extrusion unit configured to extrude a material into a cavity in a mold in an injection molding process, and the information processing device acquires, for each cycle, cycle data including extrusion unit position time-series information indicating a time series of a position of the extrusion unit controlled by the injection molding apparatus in execution of the cycle, and when the extrusion unit is retracted in the injection molding process of a first cycle which is the cycle of first cycle data among the cycle data, displays, on a display unit based on the extrusion unit position time-series information of the first cycle data, extrusion unit retraction information indicating that the extrusion unit is retracted in the injection molding process of the first cycle.

The present application is based on, and claims priority from JP Application Serial Number 2024-227101, filed December 24, 2024, the disclosure of which is hereby incorporated by reference herein in its entirety.

### BACKGROUND

### 1. Technical Field

The present disclosure relates to a molding management system.

### 2. Related Art

A technique for managing production of a product in a production process including an injection molding process of the product performed by an injection molding apparatus, has been studied and developed.

Here, a technique of displaying a graph of a waveform indicating a temporal change in a quantity controlled by an injection molding apparatus is known (see JP-A-2004-160682).

JP-A-2004-160682 is an example of the related art.

Here, when some trouble occurs in the injection molding process, an extrusion unit may be retracted. Here, the extrusion unit is a member that extrudes a material used for the injection molding apparatus to injection-mold a product into a cavity of a mold attached to the injection molding apparatus. Such retraction of the extrusion unit in the injection molding process leads to, for example, instability of a pressure in the mold in the injection molding process, which is not desirable. However, in the technique described in JP-A-2004-160682, it may be difficult to specify a cycle in which the retraction of the extrusion unit occurs in the injection molding process.

### SUMMARY

An aspect of this disclosure is a molding management system for managing production of a product in a production process including an injection molding process of the product performed by an injection molding apparatus, the molding management system including: an information processing device communicably connected to a terminal device, in which the injection molding apparatus includes an extrusion unit configured to extrude, in the injection molding process, a material used for injection molding of the product into a cavity in a mold attached to the injection molding apparatus, and the information processing device acquires cycle data from the injection molding apparatus for each cycle of performing injection molding, the cycle data including extrusion unit position time-series information indicating a time series of a position of the extrusion unit controlled by the injection molding apparatus in execution of the cycle, and when the extrusion unit is retracted in the injection molding process of a first cycle which is the cycle of first cycle data among the cycle data, displays, on a display unit based on the extrusion unit position time-series information of the first cycle data, extrusion unit retraction information indicating that the extrusion unit is retracted in the injection molding process of the first cycle.

### BRIEF DESCRIPTION OF THE DRAWINGS

FIG. 1 is a diagram showing an example of a configuration of a molding management system 1.

FIG. 2 is a diagram showing an example of a configuration of an extrusion unit.

FIG. 3 is a diagram showing an example of a search image P1.

FIG. 4 is a diagram showing an example of the search image P1 in which a search result list is displayed in a search result display region R1.

FIG. 5 is a diagram showing a first example of a waveform display image P2.

FIG. 6 is a diagram showing a second example of the waveform display image P2.

FIG. 7 is a diagram showing a third example of the waveform display image P2.

FIG. 8 is a diagram showing a fourth example of the waveform display image P2.

FIG. 9 is a diagram showing a fifth example of the waveform display image P2.

FIG. 10 is a diagram showing a sixth example of the waveform display image P2.

FIG. 11 is a diagram showing a seventh example of the waveform display image P2.

FIG. 12 is a diagram showing an eighth example of the waveform display image P2.

FIG. 13 is a diagram showing an example of a state in which an enlarged image P3 is displayed on a graph shown in FIG. 12.

FIG. 14 is a diagram showing an example of a hardware configuration of an information processing device X.

FIG. 15 is a diagram showing an example of a functional configuration of the information processing device X.

FIG. 16 is a diagram showing an example of a flow of processing performed by the information processing device X in response to a received operation.

### DESCRIPTION OF EMBODIMENTS

### Embodiment

An embodiment of the disclosure will be described below with reference to the drawings.

### Overview of Molding Management System

First, an overview of a molding management system according to the embodiment will be described.

The molding management system according to the embodiment manages production of a product in a production process including an injection molding process of the product performed by an injection molding apparatus. The molding management system includes an information processing device. Here, the injection molding apparatus includes an extrusion unit configured to extrude, in the injection molding process, a material used for injection molding of the product into a cavity in a mold attached to the injection molding apparatus. Meanwhile, the information processing device is communicably connected to a terminal device. Further, the information processing device acquires cycle data from the injection molding apparatus for each cycle of performing injection molding, and the cycle data includes extrusion unit position time-series information indicating a time series of a position of the extrusion unit controlled by the injection molding apparatus in execution of the cycle. Further, when the extrusion unit is retracted in the injection molding process of a first cycle which is the cycle of first cycle data among the cycle data, the information processing device displays, on a display unit based on the extrusion unit position time-series information of the first cycle data, extrusion unit retraction information indicating that the extrusion unit is retracted in the injection molding process of the first cycle. Accordingly, the molding management system can easily specify the cycle in which the retraction of the extrusion unit occurs in the injection molding process.

In the following description, a configuration of the molding management system according to such an embodiment and processing performed by a server provided in the molding management system will be described in detail.

### Configuration of Molding Management System

Hereinafter, the configuration of the molding management system according to the embodiment will be described by taking a molding management system 1 as an example.

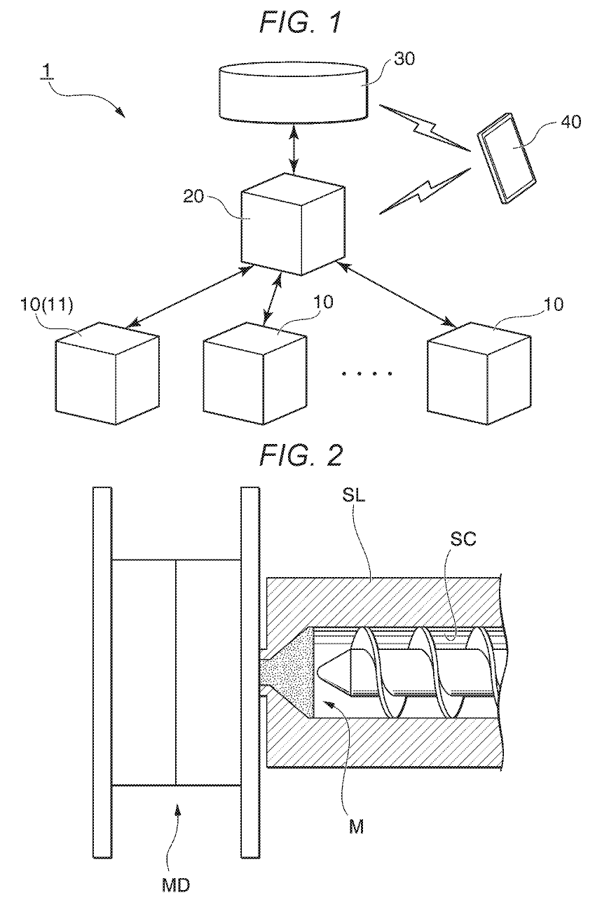

FIG. 1 is a diagram showing an example of a configuration of the molding management system 1.

The molding management system 1 is a type of manufacturing execution system (MES). For example, the molding management system 1 includes one or more managed devices 10, an information processing device 20, and a server 30. The molding management system 1 may not include a part or all of the one or more managed devices 10. The molding management system 1 may include the server 30 without including the information processing device 20. Further, the molding management system 1 may include the information processing device 20 without including the server 30. In the molding management system 1, the information processing device 20 may be configured integrally with the server 30. Hereinafter, as an example, a case in which the molding management system 1 includes a plurality of managed devices 10 as the one or more managed devices 10 will be described. Hereinafter, as an example, a case in which the molding management system 1 includes both the information processing device 20 and the server 30 separate from the information processing device 20 will be described. At least one of the information processing device 20 and the server 30 is an example of the information processing device.

Each of the plurality of managed devices 10 provided in the molding management system 1 is a device managed by the molding management system 1. In FIG. 1, for convenience of description, the plurality of managed devices 10 are indicated by the same reference numeral. However, a part or all of the plurality of managed devices 10 may be devices of types different from one another. The plurality of managed devices 10 include at least one injection molding apparatus that performs injection molding of a product using resin such as plastic. An injection molding apparatus 11 shown in FIG. 1 is an example of such an injection molding apparatus. The plurality of managed devices 10 may include an injection molding apparatus that performs metal injection molding (MIM) of a product. Hereinafter, for convenience of description, injection molding of a product using resin such as plastic is simply referred to as injection molding. Hereinafter, the injection molding apparatus that performs the injection molding of a product using resin such as plastic is simply referred to as an injection molding apparatus. At least one injection molding apparatus in the plurality of managed devices 10 may be a device that performs injection molding using a material other than resin and metal. In addition to the injection molding apparatus, the plurality of managed devices 10 include, for example, peripheral equipment of the injection molding apparatus. Examples of the peripheral equipment of the injection molding apparatus include, but are not limited to, a material supply device, a conveying device, a cleaning device, and a sintering device. Here, the material supply device is a device that supplies a material used for injection molding of a product by the injection molding apparatus to the injection molding apparatus. The cleaning device is a device that conveys a product injection-molded by the injection molding apparatus. The cleaning device is a device that cleans a product injection-molded by the injection molding apparatus. The sintering device is a device that sinters a product after being cleaned by the cleaning device.

The molding management system 1 manages production of a product in a production process including an injection molding process of the product performed by the injection molding apparatus in the plurality of managed devices 10. Here, the injection molding apparatus in the plurality of managed devices 10 may have any configuration as long as the configuration is capable of producing a product by injection molding. Hereinafter, for convenience of description, a process in which the injection molding apparatus performs injection molding of a product once is referred to as a cycle. Hereinafter, for convenience of description, a cavity in a mold attached to the injection molding apparatus is referred to as a cavity. That is, the injection molding apparatus performs injection molding of a product by injecting a material into the cavity in the mold attached to the injection molding apparatus and applying a pressure to the material in the cavity.

Here, one or more injection molding apparatuses in the plurality of managed devices 10 each include an extrusion unit that extrudes, in the injection molding process, a material used for injection molding of the product into the cavity in the mold attached to the injection molding apparatus. Here, FIG. 2 is a diagram showing an example of a configuration of the extrusion unit. FIG. 2 shows a mold MD that is an example of the mold attached to the injection molding apparatus, a cylinder SL that injects a material M used for injection molding of a product into the mold MD, and an extrusion unit SC that extrudes and injects the material M filled in the cylinder SL from an injection port formed at a tip end of the cylinder SL toward a cavity of the mold MD. Here, in the example shown in FIG. 2, the extrusion unit SC is a screw that rotates in the cylinder SL to move a position thereof in the cylinder SL back and forth. The extrusion unit SC may be a member that moves a position thereof in the cylinder SL back and forth by hydraulic pressure, a linear motion actuator, or the like, instead of the screw. The material M is extruded from the injection port of the cylinder SL toward the cavity in the mold MD in response to advance of the extrusion unit SC in the cylinder SL. Hereinafter, for convenience of description, the extrusion unit provided in the injection molding apparatus is referred to as the screw.

Further, one or more detection units are attached to the one or more injection molding apparatuses in the plurality of managed devices 10. The one or more detection units detect a quantity controlled by the injection molding apparatus in each cycle. The quantity controlled by the injection molding apparatus in each cycle is, for example, a part or all of a screw position, an injection speed that is a speed at which the material is injected into the cavity in the mold by the screw, a screw rotation speed, an injection holding pressure that is a pressure in the mold held by the screw, and a temperature in the mold, but is not limited thereto. Hereinafter, for convenience of description, the quantity detected by each of the one or more detection units attached to each of the one or more injection molding apparatuses in the plurality of managed devices 10 is simply referred to as a detection quantity. A detection unit that detects a certain detection quantity among the one or more detection units attached to a certain injection molding apparatus is, for example, a sensor that detects the detection quantity, but is not limited thereto. The one or more detection units may include a detection unit that detects a quality of the product. This is because the quality of the product is also controlled by the injection molding apparatus in each cycle. In this case, the detection unit is, for example, a device that includes an imaging unit capable of imaging the product to detect the quality of the product, but is not limited thereto. In this case, for example, a quantity indicating the quality of the product detected by the detection unit is, for example, any of a plurality of predetermined values arranged in descending order of quality, but is not limited thereto.

The information processing device 20 acquires the cycle data for each cycle from each of the one or more injection molding apparatuses in the plurality of managed devices 10. More specifically, the information processing device 20 acquires the cycle data from each of the one or more injection molding apparatuses every time each cycle ends. Hereinafter, for convenience of description, the cycle data acquired when a certain cycle ends is referred to as cycle data of the cycle. Hereinafter, for convenience of description, a cycle that ends when certain cycle data is acquired will be referred to as a cycle of the cycle data.

The cycle data acquired from a certain injection molding apparatus in a certain cycle is information including one or more pieces of cycle-related information obtained in response to execution of the cycle by the injection molding apparatus, apparatus identification information for identifying the injection molding apparatus, and first date-and-time information indicating a date and time when the cycle data is acquired by the information processing device 20 from the injection molding apparatus. The apparatus identification information is, for example, an identifier (ID) for identifying the injection molding apparatus, and may be other information through which the injection molding apparatus can be identified, such as an Internet protocol (IP) address assigned to the injection molding apparatus. The first date-and-time information may be a time stamp or other information indicating the date and time. The cycle data may include other information in addition to the one or more pieces of cycle-related information, the apparatus identification information, and the first date-and-time information. Further, the apparatus identification information may be included in the cycle data as any piece of the one or more pieces of cycle-related information. Hereinafter, as an example, a case will be described in which the apparatus identification information is contained in the cycle data as any one of the one or more pieces of cycle-related information.

The one or more pieces of cycle-related information included in the cycle data acquired from a certain injection molding apparatus in a certain cycle include one or more pieces of detection quantity information in addition to the apparatus identification information for identifying the injection molding apparatus. Each of the one or more pieces of detection quantity information is information indicating a value of each detection quantity controlled by the injection molding apparatus. The detection quantity information indicating a value of a certain detection quantity includes time-series information indicating a time series of the detection quantity and feature value information indicating one or more types of feature values for the detection quantity. Here, the one or more types of feature values for the certain detection quantity are, for example, at least one of a minimum value, a maximum value, an average value, a variance, and a standard deviation of the detection quantity, a start value of a period in which the detection quantity is detected, and an end value of the period. That is, the one or more types of feature values are values indicating features of a waveform indicating a temporal change in the detection quantity. The one or more types of feature values may include another value obtained by performing statistical processing on the detection quantity, instead of a part or all of the feature values or in addition to all of the feature values. The feature value information may be contained in the detection quantity information in the injection molding apparatus or the information processing device 20. This is because the information processing device 20 can calculate the one or more types of feature values based on the time-series information. The detection quantity information may not include the feature value information as long as including the time-series information. Hereinafter, as an example, a case in which only the time-series information is included in the detection quantity information will be described. In this case, the detection quantity information is the time-series information itself. Hereinafter, for convenience of description, when it is desired to distinguish time-series information indicating a time series of the position of the screw among the one or more pieces of detection quantities controlled by the injection molding apparatus from other time-series information, the time-series information is simply referred to as screw position time-series information. The screw position time-series information is an example of the extrusion unit position time-series information.

The one or more pieces of cycle-related information included in the cycle data acquired from the certain injection molding apparatus in the certain cycle may include other information in addition to the apparatus identification information and one or more pieces of feature value information. The other information is, for example, a part or all of operation state information and product quantity information, but is not limited thereto. Here, the operation state information included in the cycle data as the cycle-related information is information indicating an operation state of the injection molding apparatus. The product quantity information included in the cycle data as the cycle-related information is information indicating the number of products injection-molded by the injection molding apparatus in the cycle.

The cycle data as described above can be distinguished by a combination of the apparatus identification information and the first date-and-time information. When there is only one injection molding apparatus coupled to the information processing device 20, the cycle data may not include the apparatus identification information. This is because, in this case, the cycle data can be distinguished simply by the first date-and-time information.

When a certain piece of cycle data is acquired, the information processing device 20 stores the acquired cycle data and outputs the acquired cycle data to the server 30. Accordingly, the information processing device 20 can also store the acquired cycle data in the server 30.

Further, the information processing device 20 acquires the injection molding condition data from each of the one or more injection molding apparatuses in the plurality of managed devices 10 every time an injection molding condition is set in the injection molding apparatus.

Here, the injection molding condition data acquired from a certain injection molding apparatus is information in which one or more pieces of injection molding condition information each indicating the injection molding condition set in the injection molding apparatus, the apparatus identification information for identifying the injection molding apparatus, and second date-and-time information indicating a date and time when the injection molding condition data is acquired by the information processing device 20 from the injection molding apparatus are associated with one another. The apparatus identification information is, for example, an ID for identifying the injection molding apparatus, but may be other information through which the injection molding apparatus can be identified, such as an IP address assigned to the injection molding apparatus. The second date-and-time information may be a time stamp or other information indicating the date and time. The injection molding condition data may include other information in addition to the one or more pieces of injection molding condition information, the apparatus identification information, and the second date-and-time information. The apparatus identification information may be included in the injection molding condition data as any piece of the one or more pieces of injection molding condition information. Hereinafter, as an example, a case in which the apparatus identification information is included in the injection molding condition data as any piece of the one or more pieces of injection molding condition information will be described.

The one or more pieces of injection molding condition information included in the injection molding condition data acquired from a certain injection molding apparatus include one or more pieces of target value information in addition to the apparatus identification information for identifying the injection molding apparatus. Each of the one or more pieces of target value information is information indicating one or more target values in the control for each detection quantity performed by the injection molding apparatus. Therefore, the target value information indicating one or more target values for a certain detection quantity is associated with the detection quantity. A method of associating the detection quantity with the target value information may be a known method or a method to be developed in the future. A reason why the one or more pieces of target value information are included in the injection molding condition data as the injection molding condition information is that, for each detection quantity in each cycle, the injection molding apparatus controls the detection quantity such that the value of the detection quantity matches the target value of the detection quantity. Here, a reason why there are one or more target values for each detection quantity is that there may be a plurality of target values as targets to which each detection quantity is to be brought close in the control performed by the injection molding apparatus in each cycle. For example, the injection speed, which is the speed at which the material is injected into the cavity in the mold by the screw, changes in a plurality of stages in the injection molding process in each cycle. In such a case, there are a plurality of target values for the detection quantity. The target value information for a certain detection quantity indicates each of the one or more target values for the detection quantity. Therefore, the injection molding condition data includes, as the injection molding condition information, the target value information of the same pieces as the number of detection units attached to the injection molding apparatus.

The one or more pieces of injection molding condition information included in the injection molding condition data acquired from a certain injection molding apparatus may include other information in addition to the apparatus identification information for identifying the injection molding apparatus and the one or more pieces of target value information. The other information is abnormality determination condition information associated with each target value set as the injection molding condition in the injection molding apparatus or the like, but is not limited thereto. Here, the abnormality determination condition information associated with a certain target value is information indicating an abnormality determination condition satisfied by a value of a detection quantity corresponding to the target value when no abnormality occurs in the value of the detection quantity in the control in which the injection molding apparatus causes the value of the detection quantity to match the target value. A method of associating the target value with the abnormality determination condition information may be a known method or a method to be developed in the future. The abnormality determination condition may be any condition as long as the condition is satisfied by the value of the detection quantity when no abnormality occurs in the value of the detection quantity in the control.

The injection molding condition data as described above can be distinguished by a combination of the apparatus identification information and the second date-and-time information. When there is only one injection molding apparatus coupled to the information processing device 20, the injection molding condition data may not include the apparatus identification information. This is because, in this case, each piece of injection molding condition data can be distinguished simply by the second date-and-time information.

When a certain piece of injection molding condition data is acquired, the information processing device 20 stores the acquired injection molding condition data and outputs the acquired injection molding condition data to the server 30. Accordingly, the information processing device 20 can also store the acquired injection molding condition data in the server 30. Here, the information processing device 20 associates the injection molding condition data indicating the injection molding conditions set in a certain injection molding apparatus in a certain cycle with the cycle data acquired from the injection molding apparatus in the cycle. Such an association method may be a known method or may be a method to be developed in the future. By such association, at least one piece of injection molding condition data is associated with each piece of cycle data. Hereinafter, as an example, a case in which one piece of injection molding condition data is associated with each piece of cycle data will be described.

In response to a request from the terminal device communicably connected to the information processing device 20, the information processing device 20 displays, on a display unit of the terminal device, various images based on the data stored in the information processing device 20. Here, the images are a graphical user interface (GUI), an icon, a window on an operating system (OS), and the like. Hereinafter, as an example, a case in which the information processing device 20 is communicably connected to the terminal device 40 as shown in FIG. 1 will be described. In the present embodiment, since processing related to login to the information processing device 20 via the terminal device 40 is known processing, a description thereof will be omitted. Hereinafter, for convenience of description, the information processing device 20 receiving an operation from the terminal device 40 via an image displayed on the terminal device 40 is simply referred to as the information processing device 20 receiving an operation. That is, hereinafter, the information processing device 20 performing certain processing in response to a received operation means the information processing device 20 performing the processing in response to an operation received from the terminal device 40 via the image displayed on the terminal device 40.

Examples of the information processing device 20 include, but are not limited to, a workstation, a desktop personal computer (PC), and a notebook PC. The information processing device 20 is communicably connected to each of the plurality of managed devices 10 by wired or wireless communication. Examples of a communication network that connects the information processing device 20 and the plurality of managed devices 10 include, but are not limited to, a Local Area Network (LAN) in a facility in which the plurality of managed devices 10 are installed. The communication network may be another communication network such as the Internet or a mobile communication network.

The server 30 stores the cycle data acquired by the information processing device 20. For example, when a certain piece of cycle data is acquired from the information processing device 20, the server 30 stores the acquired cycle data.

The server 30 stores the injection molding condition data acquired by the information processing device 20. For example, when a certain piece of injection molding condition data is acquired from the information processing device 20, the server 30 stores the acquired injection molding condition data.

In response to a request from a terminal device communicably connected to the server 30, the server 30 displays, on a display unit of the terminal device, various images based on the data stored in the server 30. Here, the images are the GUI, the icon, the window on the OS, and the like. Hereinafter, as an example, a case in which the server 30 is communicably connected to the terminal device 40 as shown in FIG. 1 will be described. In the present embodiment, since processing related to login to the server 30 via the terminal device 40 is known processing, a description thereof will be omitted. Hereinafter, for convenience of description, the server 30 receiving an operation from the terminal device 40 via the image displayed on the terminal device 40 is simply referred to as the server 30 receiving an operation. That is, hereinafter, the server 30 performing certain processing in response to a received operation means the server 30 performing the processing in response to an operation received from the terminal device 40 via the image displayed on the terminal device 40.

As described above, in the molding management system 1, both the information processing device 20 and the server 30 display, in response to the received operation, various images based on the stored data on the display unit of the terminal device 40. Therefore, hereinafter, for convenience of description, the information processing device 20 and the server 30 are collectively referred to as an information processing device X unless it is necessary to distinguish the information processing device 20 and the server 30. Examples of the display unit include, but are not limited to, a display of the terminal device 40 and a display device communicably connected to the terminal device 40. Hereinafter, as an example, a case in which the display unit is the display of the terminal device 40 will be described. Hereinafter, for convenience of description, displaying a certain image on the display unit is referred to as displaying an image.

Here, the information processing device X displays an image related to the cycle data in response to a received operation. For example, the information processing device X displays an image related to a certain piece of cycle data X1 in response to the operation. At this time, the information processing device X can determine, based on the screw position time-series information included in the cycle data X1, whether the screw is retracted in the injection molding process of a cycle of the cycle data X1. Then, when the screw is retracted in the injection molding process, the information processing device X displays screw retraction information indicating that the screw is retracted in the injection molding process. The information processing device X may display the screw retraction information on the image, or may display the screw retraction information on an image other than the image. With such display of the screw retraction information, the information processing device X can make it possible for the user to easily specify the cycle in which the retraction of the screw occurs in the injection molding process. Hereinafter, for convenience of description, the image for displaying the screw retraction information indicating that the screw is retracted in the injection molding process of a certain cycle is referred to as a screw retraction information display image. The screw retraction information is an example of the extrusion unit retraction information.

For example, a search image P1 in which a list of the cycle data designated among the cycle data stored in the information processing device X is displayed is an example of the screw retraction information display image described above.

For example, the information processing device X displays, in response to a received operation, the search image P1 for searching for one or more pieces of cycle data desired by the user among the one or more pieces of cycle data stored in the information processing device X. The search image P1 is an image for receiving various types of information that can be used as a search key for searching for the one or more pieces of cycle data desired by the user. Hereinafter, in order to simplify the description, as an example, a case will be described in which the search image P1 can receive, as the search key, each of the apparatus identification information for identifying the injection molding apparatus that outputs the cycle data and period information indicating a period including the date and time when the cycle data is acquired by the information processing device 20.

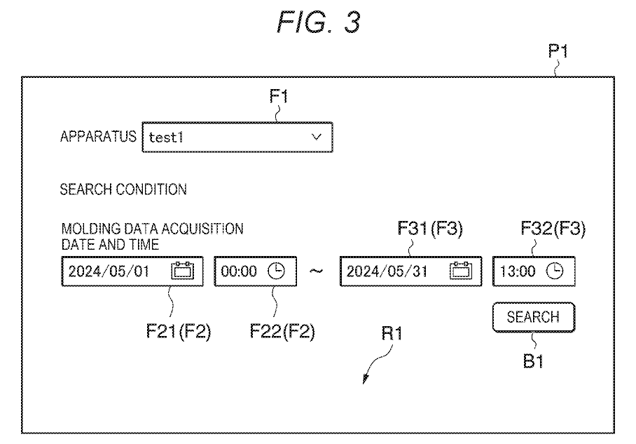

FIG. 3 is a diagram showing an example of the search image P1. In the example shown in FIG. 3, the search image P1 includes an input field F1, an input field F2, an input field F3, a button B1, and a search result display region R1. The search image P1 may include another GUI capable of receiving an operation of searching for the cycle data instead of a part or all of these GUIs or in addition to all of these GUIs.

The input field F1 is a field for inputting the apparatus identification information for identifying the injection molding apparatus that outputs the cycle data desired by the user. In the example shown in FIG. 3, "test 1" is input to the input field F1 as an example of the apparatus identification information. The apparatus identification information may be input to the input field F1 by selecting the apparatus identification information from a pull-down menu or may be directly input using an input device such as a keyboard.

The input field F2 and the input field F3 are fields for inputting the period information indicating a period including a date and time desired by the user to acquire the cycle data via the information processing device 20. In the example shown in FIG. 3, the input field F2 is a field for inputting start date-and-time information indicating a date and time when the period starts. In this example, the input field F3 is a field for inputting end date-and-time information indicating a date and time when the period ends.

More specifically, the input field F2 includes two input fields, that is, an input field F21 and an input field F22. The input field F21 is a field for inputting start date information indicating a date in the date and time indicated by the start date-and-time information. In the example shown in FIG. 3, in the input field F21, "2024/05/01" indicating May 1, 2024 is input as an example of the start date information. The start date information may be input to the input field F21 by selecting information from a pull-down menu, may be input by selecting a date from an image indicating a calendar, or may be directly input using an input device such as a keyboard. Meanwhile, the input field F22 is a field for inputting start time information indicating a time in the date and time indicated by the start date-and-time information. In the input field F22, "00:00" indicating zero o'clock is input as an example of the start time information. The start time information may be input to the input field F22 by selecting information from a pull-down menu, may be input by designating a time on an image indicating a clock, or may be directly input using an input device such as a keyboard.

The input field F3 includes two input fields, that is, an input field F31 and an input field F32. The input field F31 is a field for inputting end date information indicating a date in the date and time indicated by the end date-and-time information. In the example shown in FIG. 3, in the input field F31, "2024/05/31" indicating May 31, 2024 is input as an example of the end date information. The end date information may be input to the input field F31 by selecting information from a pull-down menu, may be input by selecting a date from an image indicating a calendar, or may be directly input using an input device such as a keyboard. Meanwhile, the input field F32 is a field for inputting end time information indicating a time in the date and time indicated by the end date-and-time information. In the input field F32, "13:00" indicating one o'clock pm is input as an example of the end time information. The end time information may be input to the input field F32 by selecting information from a pull-down menu, may be input by designating a time on an image indicating a clock, or may be directly input using an input device such as a keyboard.

The button B1 is a button for receiving an operation of using each piece of information input to a part or all of the input field F1 to the input field F3 as the search key to search for the cycle data based on the search key. That is, when a selection operation on the button B1 is received, the information processing device X extracts, as a search result, one or more pieces of cycle data corresponding to the respective pieces of information input to a part or all of the input field F1 to the input field F3. Then, the information processing device X displays a list of the extracted one or more pieces of cycle data in the search result display region R1. In the present embodiment, the selection operation means a click, a tap, or the like, but is not limited thereto. The search image P1 shown in FIG. 3 is an image before the one or more pieces of cycle data are extracted. Therefore, nothing is displayed in the search result display region R1 shown in FIG. 3. Hereinafter, for convenience of description, the list of one or more pieces of cycle data extracted by the information processing device X is simply referred to as a search result list. A method of extracting one or more pieces of cycle data corresponding to the respective pieces of information input to a part or all of the input field F1 to the input field F3, that is, a method of searching for the one or more pieces of cycle data may be a known method or a method to be developed in the future. Therefore, in the present embodiment, a detailed description of the extraction method will be omitted. The information processing device X may be configured to, when no information is input to all of the input field F1 to the input field F3 and a selection operation is performed on the button B1, display a list of all of the one or more pieces of cycle data stored in advance in the search result display region R1 as the search result list, or display nothing in the search result display region R1.

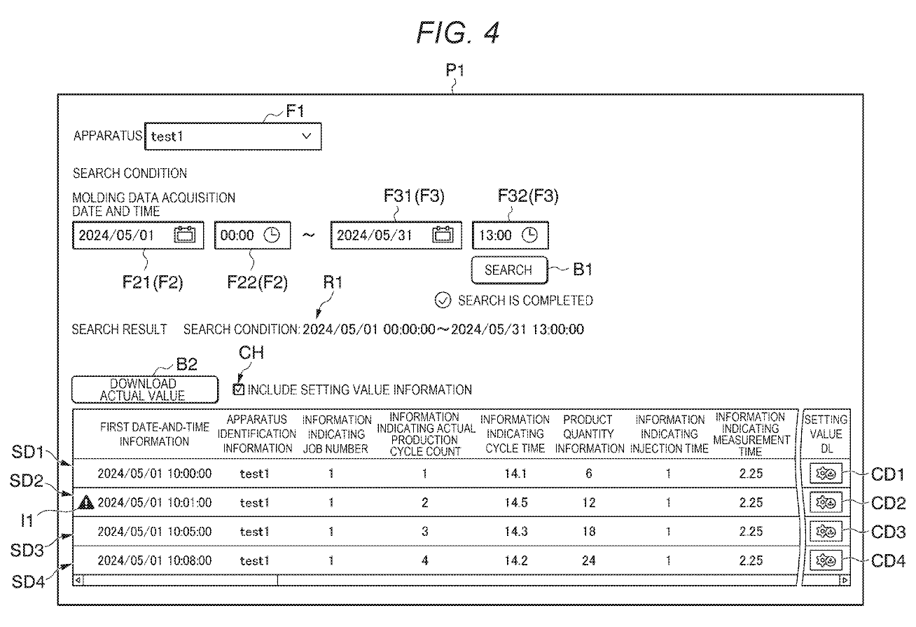

FIG. 4 is a diagram showing an example of the search image P1 in which the search result list is displayed in the search result display region R1. In the example shown in FIG. 4, in the search result display region R1, a search result list including four pieces of cycle data, that is, cycle data SD1 to cycle data SD4 is displayed. In addition to the first date-and-time information and the apparatus identification information, each of the four pieces of cycle data includes, as the cycle-related information, information indicating a job number, information indicating an actual production cycle count, information indicating a cycle time, the product quantity information, information indicating an injection time, information indicating a measurement time, and the like. Further, in the search result display region R1, in association with each of the four pieces of cycle data, association information indicating the injection molding condition associated with a corresponding piece of cycle data is displayed. That is, in the search result display region R1, association information CD1 is displayed in association with the cycle data SD1. The association information CD1 is information indicating the injection molding condition data associated with the cycle data SD1. In the search result display region R1, association information CD2 is displayed in association with the cycle data SD2. The association information CD2 is information indicating the injection molding condition data associated with the cycle data SD2. In the search result display region R1, association information CD3 is displayed in association with the cycle data SD3. The association information CD3 is information indicating the injection molding condition data associated with the cycle data SD3. In the search result display region R1, association information CD4 is displayed in association with the cycle data SD4. The association information CD4 is information indicating the injection molding condition data associated with the cycle data SD4. In this way, when displaying the search result list in the search result display region R1, the information processing device X displays the association information indicating the injection molding condition data associated with respective pieces of cycle data contained in the search result list in the search result display region R1, together with the respective pieces of cycle data. Accordingly, the information processing device X can make it possible to easily grasp a relation between the cycle of injection molding in the injection molding apparatus and the injection molding condition set in the injection molding apparatus. In the example shown in FIG. 4, the association information indicating the injection molding condition data associated with the corresponding piece of cycle data is an image not including the injection molding condition data itself. Therefore, in this example, the user cannot visually grasp the injection molding condition data associated with the corresponding piece of cycle data simply by the information displayed in the search result display region R1 shown in FIG. 4. Therefore, as described above, each piece of association information may include at least a part of the injection molding condition data indicated by the association information. In this case, the user can visually grasp the injection molding condition data associated with the corresponding piece of cycle data simply by the information displayed in the search result display region R1. As a result, the information processing device X can make it possible to more reliably and easily grasp the relation between the cycle of injection molding in the injection molding apparatus and the injection molding condition set in the injection molding apparatus.

Here, in the example shown in FIG. 4, each of the association information CD1 to the association information CD4 is an image for receiving an operation of outputting the injection molding condition data indicated by a corresponding piece of the association information to another device. The other device may be, for example, the terminal device 40 or another information processing device communicably connected to the information processing device X. For example, when a selection operation on the association information CD1 is received, the information processing device X outputs the injection molding condition data associated with the cycle data SD1 to the terminal device 40 as the injection molding condition data indicated by the association information CD1. Accordingly, the user can easily download the injection molding condition data to the terminal device 40. The same also applies to each of the association information CD2 to the association information CD4. By outputting the injection molding condition data to the terminal device 40 by an operation on the association information in this way, when the user wants to acquire desired injection molding condition data, it is not necessary to search for the desired injection molding condition data from among many pieces of injection molding condition data, and the desired injection molding condition data can be easily acquired. This prevents the user from acquiring erroneous injection molding condition data and is useful. For example, the information processing device X outputs the injection molding condition data to the terminal device 40 as a CSV (Comma Separated Values) file, but is not limited thereto.

As shown in FIG. 4, when displaying the search result list in the search result display region R1, the information processing device X displays the search result list in the search result display region R1 in order of the date and time indicated by the first date-and-time information included in the cycle data. Specifically, in the search result display region R1 shown in FIG. 4, four pieces of cycle data are displayed in ascending order of the date and time. Accordingly, the information processing device X can make it possible to confirm the plurality of pieces of cycle data displayed in the search result display region R1 in chronological order. In the search result display region R1, a plurality of pieces of cycle data may be displayed in descending order of the date and time.

Here, when the cycle data of a certain cycle in which the screw is retracted in the injection molding process is included in the search result list, the information processing device X displays an icon indicating that the screw is retracted in the injection molding process of the cycle, as the screw retraction information at a position corresponding to the cycle data among positions in the search result display region R1. Hereinafter, for convenience of description, the icon is referred to as a screw retraction icon. Accordingly, the information processing device X can make it possible for the user to easily specify the cycle data of the cycle in which the screw is retracted in the injection molding process from among the cycle data included in the search result list. An icon I1 shown in FIG. 4 is an example of a screw retraction icon. In the example shown in FIG. 4, the icon I1 is displayed at a position adjacent to the first date-and-time information of the cycle data SD2 in the search result list. The position is an example of the position corresponding to the cycle data SD2 among the positions in the search result display region R1, but is not limited thereto. Instead of a design shown in FIG. 4, the icon I1 may have another design indicating that the screw is retracted in the injection molding process of the cycle.

As described above, when the cycle data of a certain cycle in which the screw is retracted in the injection molding process is included in the search result list, the information processing device X displays, in the search image P1 which is an example of the screw retraction information display image, the screw retraction information at a position corresponding to the cycle data among the positions in the search result display region R1. Accordingly, the information processing device X can make it possible for the user to easily specify the cycle in which the retraction of the screw occurs.

Further, for example, a waveform display image P2 displaying a graph of a waveform indicating a temporal change of a value indicated by designated detection quantity information among the detection quantity information included in the designated cycle data is also an example of the screw retraction information display image described above.

The information processing device X selects, in response to a received operation, one piece of cycle data desired by the user among the one or more pieces of cycle data stored in the information processing device X as target cycle data. After selecting the target cycle data, the information processing device X selects one piece of detection quantity information desired by the user from among the detection quantity information included in the target cycle data as target detection quantity information, in response to a received operation. After selecting the target detection quantity information, the information processing device X generates a graph of a waveform indicating a temporal change in a value indicated by the target detection quantity information, based on the time-series information included in the target detection quantity information. Here, the information processing device X can switch a quantity indicated by a horizontal axis of the graph to either an elapsed time in a target cycle, which is the cycle of the target cycle data, or the position of the screw in the target cycle, in response to a received operation. After generating the graph, the information processing device X displays the waveform display image P2 for displaying the generated graph.

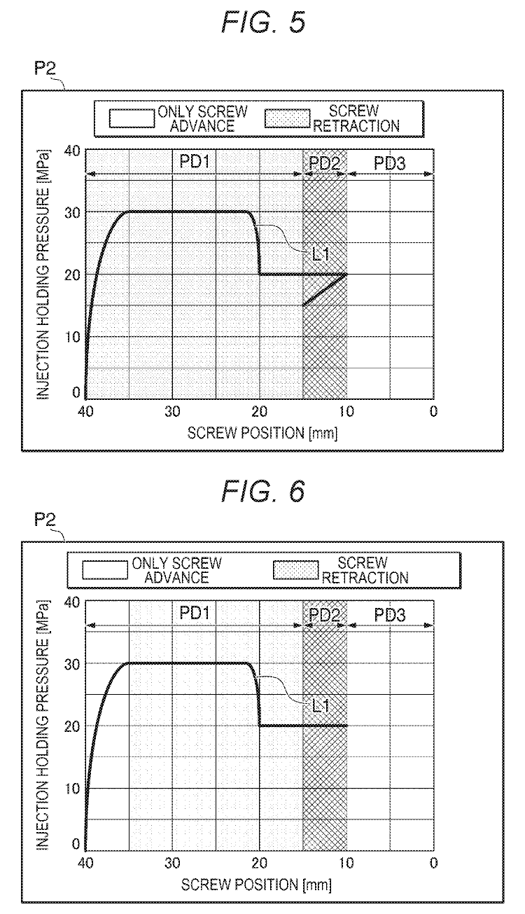

FIG. 5 is a diagram showing a first example of the waveform display image P2. A horizontal axis of a graph shown in FIG. 5 indicates the position of the screw in the injection molding process of the target cycle. A vertical axis of the graph indicates a value of the injection holding pressure as an example of a value indicated by the target detection quantity information. A waveform L1 plotted on the graph is an example of a waveform indicating a temporal change in the value of the injection holding pressure. In the example shown in FIG. 5, in a section PD1 in which the position of the screw in the target cycle is from 40 mm to 15 mm, the screw is only advanced and is not retracted. Meanwhile, in this example, in a section PD2 in which the position of the screw in the target cycle is from 15 mm to 10 mm, the screw is advanced and then retracted. In this way, when the screw is retracted in the injection molding process of the target cycle, the information processing device X displays the screw retraction information on the graph.

Specifically, for example, when displaying the screw retraction information on the graph shown in FIG. 5, the information processing device X displays, as the screw retraction information, information indicating a screw retraction section in which the screw is retracted in the injection molding process among the sections on the graph. In the example shown in FIG. 5, the screw retraction section is the section PD2. Therefore, in this example, the information processing device X displays information indicating the section PD2 as the screw retraction information. The information processing device X may be configured to display the information as screw retraction information on the graph, or display the information as screw retraction information separately from the graph. In the example shown in FIG. 5, the information processing device X displays a display mode of the screw retraction section as the screw retraction information, by making a display mode of the section PD2, which is the screw retraction section, different from a display mode of a screw non-retraction section other than the screw retraction section on the graph. The section PD1 is an example of the screw non-retraction section on the graph. A section PD3 in which the position of the screw in the target cycle is from 10 mm to 0 mm is also an example of the screw non-retraction section on the graph. More specifically, in this example, the information processing device X displays a background color of the section PD2 as the screw retraction information, by making the background color of the section PD2 different from a background color of the screw non-retraction section. In FIG. 5, a difference between the background color of the section PD2 and the background color of the screw non-retraction section, such as the section PD1 and the section PD3, is indicated by the presence or absence of hatching. Further, the information processing device X may be configured to set a background color of the section PD1 to a predetermined color as a color indicating that the screw is advanced among colors different from the background color of the section PD2, or to the same color as the background color of another screw non-retraction sections such as the section PD3. In this example, the information processing device X sets the background color of the section PD1 to a predetermined color as the color indicating that the screw is advanced among colors different from the background color of the section PD2. Further, in this example, the display modes of the section PD1 and the section PD2 are different depending on the background color, which is merely an example, and may be different depending on other display modes such as shading, brightness, and hatching of a background. In this example, the difference in background color may be a difference in gradation.

Here, in the example shown in FIG. 5, it can be seen from the waveform L1 whether the screw is retracted. However, whether it is possible to determine whether the screw is retracted by looking at the waveform L1, depends on a shape of the waveform L1. For example, when the shape of the waveform L1 is a shape shown in FIG. 6, whether the screw is retracted is not known even by viewing the waveform L1. FIG. 6 is a diagram showing a second example of the waveform display image P2. A graph shown in FIG. 6 is the same as the graph shown in FIG. 5 except that the shape of the plotted waveform L1 is different. In the waveform L1 shown in FIG. 6, in the section PD2, the value of the injection holding pressure when the screw is advanced and the value of the injection holding pressure when the screw is retracted are substantially the same. Therefore, in the section PD2, a waveform indicating the temporal change in the injection holding pressure when the screw is advanced and a waveform indicating the temporal change in the injection holding pressure when the screw is retracted substantially overlap each other. In such a case, even if the screw is retracted, it is difficult to determine whether the screw is retracted from the shape of the waveform L1. Further, whether the value of the injection holding pressure is substantially unchanged varies depending on a scale interval of a vertical axis of the graph shown in FIG. 6. Therefore, in such a sense, it is not desirable to determine whether the screw is retracted from the shape of the waveform L1 because a subjective view of the user is included. Therefore, displaying the screw retraction information indicating the screw retraction section on the graph, as performed by the information processing device X, leads to objectively determining whether the screw is retracted in the injection molding process, and is useful.

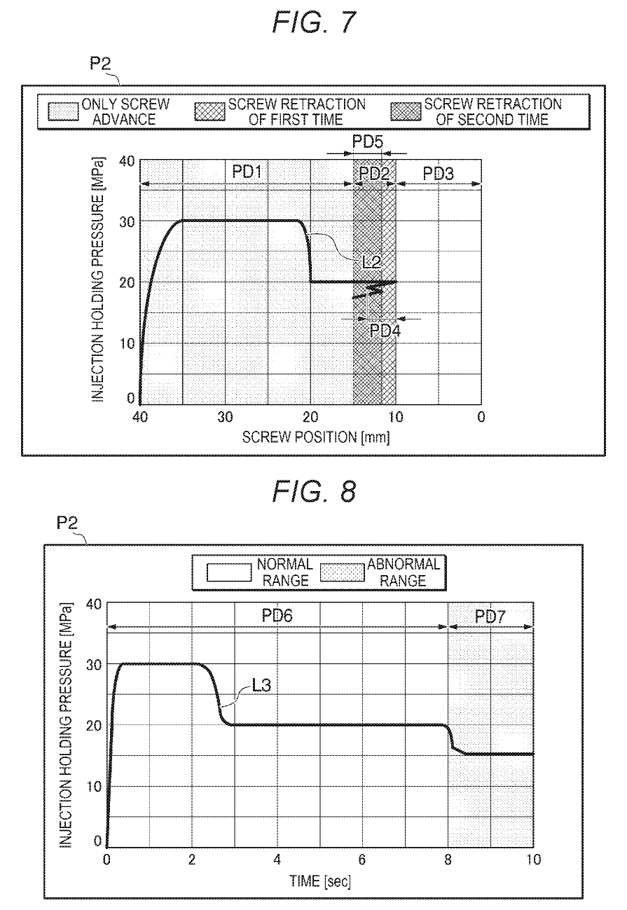

The information processing device X may be configured to, when the screw is retracted N times or more in the injection molding process of the target cycle, make the display modes of the respective screw retraction sections for the retraction of the screw that occurs N times different on the graph of the waveform indicating the temporal change in the value of the injection holding pressure, as shown in FIG. 7. In this case, the information processing device X displays the display modes of the respective screw retraction sections for the retraction of the screw that occurs N times, as the screw retraction information indicating the retraction of the screw that occurs N times. N may be any integer equal to or greater than 2.

FIG. 7 is a diagram showing a third example of the waveform display image P2. A graph shown in FIG. 7 is the same as the graph shown in FIG. 5 except that a waveform L2 is plotted. The waveform L2 shown in FIG. 7 has the same shape as the waveform L1 shown in FIGS. 5 and 6 in the section PD1. Meanwhile, in the waveform L2 shown in FIG. 7, the retraction of the screw occurs twice in the section PD2. In FIG. 7, a section in the section PD2 in which retraction of the screw of a first time occurs is shown as a section PD4. In FIG. 7, a section in the section PD2 in which retraction of the screw of a second time occurs is shown as a section PD5. In FIG. 7, the information processing device X makes a display mode of the section PD4 different from a display mode of the section PD5. More specifically, in the example shown in FIG. 7, the information processing device X makes a background color of the section PD4 different from a background color of the section PD5. Accordingly, the information processing device X displays the display mode of the section PD4 and the display mode of the section PD5 as the screw retraction information indicating the retraction of the screw that occurs twice. In FIG. 7, a difference in display mode among the section PD1, the section PD4, and the section PD5 is represented by a difference in hatching. However, in FIG. 7, a part of the section PD4 overlaps with the section PD5, and thus is not visible. A background color of a section in which the section PD4 and the section PD5 overlap may be the background color of the section PD5 as shown in FIG. 7, may be the background color of the section PD4, or may be a background color different from the background colors of the section PD4 and the section PD5.

Here, the horizontal axis of each of the graphs shown in FIGS. 5 to 7 is the position of the screw. Therefore, in each of the graphs of FIGS. 5 and 7 among the graphs shown in FIGS. 5 to 7, the user can determine whether the screw is retracted from the waveform plotted on the graph. However, when a horizontal axis of a graph of a waveform indicating a temporal change in a value of a target detection quantity indicates an elapsed time, the user cannot determine whether the screw is retracted from a shape of the waveform. FIG. 8 is a diagram showing a fourth example of the waveform display image P2. A graph shown in FIG. 8 is a graph in which a quantity indicated by the horizontal axis of the graph shown in FIG. 5 is changed from the position of the screw in the injection molding process of the target cycle to an elapsed time in the injection molding process of the target cycle. Therefore, a waveform L3 plotted on the graph shown in FIG. 8 shows a change similar to the waveform L1 plotted on the graph shown in FIG. 5 as the temporal change in the injection holding pressure. However, in the graph shown in FIG. 8, since the horizontal axis of the graph indicates the elapsed time, the waveform L3 monotonically extends in a positive direction of the horizontal axis. Therefore, the information processing device X displays information indicating the screw retraction section on the graph as the screw retraction information. A section PD6 in the graph is a section in which the screw is only advanced. Since the horizontal axis of the graph indicates the elapsed time, the section PD6 in the graph may be referred to as a period in which the screw is only advanced. Meanwhile, a section PD7 in the graph is a section in which the screw is retracted. Since the horizontal axis of the graph indicates the elapsed time, the section PD7 in the graph may be referred to as a period in which the screw is retracted. Even when the horizontal axis of the graph is the elapsed time, the information processing device X can specify the section PD6 and the section PD7 based on the time-series information indicating a time series of the value of the target detection quantity, as described above. In the example shown in FIG. 8, the information processing device X makes a display mode of the section PD7, which is the screw retraction section specified based on the time-series information, different from a display mode of the section PD6. More specifically, in this example, the information processing device X makes a background color of the section PD7 different from a background color of the section PD6. Accordingly, the information processing device X can display the display mode of the section PD7 on the graph as the screw retraction information. As a result, even when the horizontal axis of the graph is the elapsed time, the information processing device X can make it possible for the user to easily specify the cycle in which the screw is retracted in the injection molding process. In FIG. 8, a difference between the display mode of the section PD7 and the display mode of the section PD6 is represented by hatching.

Instead of making the display mode of the screw retraction section different from the display mode of the screw non-retraction section as the screw retraction information displayed on the graph of the waveform indicating the temporal change in the value of the target detection quantity, the information processing device X may be configured to make a line type of a line indicating the temporal change in the value of the target detection quantity when the screw is retracted in the screw retraction section among lines indicating the waveform on the graph, different from a line type of a line indicating the temporal change in the value of the target detection quantity when the screw is not retracted among the lines indicating the waveform on the graph. Accordingly, the information processing device X can display, as the screw retraction information, the line type of the line indicating the temporal change in the value of the target detection quantity when the screw is retracted in the screw retraction section among the lines indicating the waveform on the graph. Hereinafter, for convenience of description, among lines indicating a waveform plotted on a certain graph, a line indicating a temporal change in the value of the target detection quantity when the screw is retracted in the screw retraction section is referred to as a screw retraction waveform. Hereinafter, for convenience of description, among lines indicating a waveform plotted on a certain graph, a line indicating a temporal change in the value of the target detection quantity when the screw is not retracted is referred to as a screw non-retraction waveform.

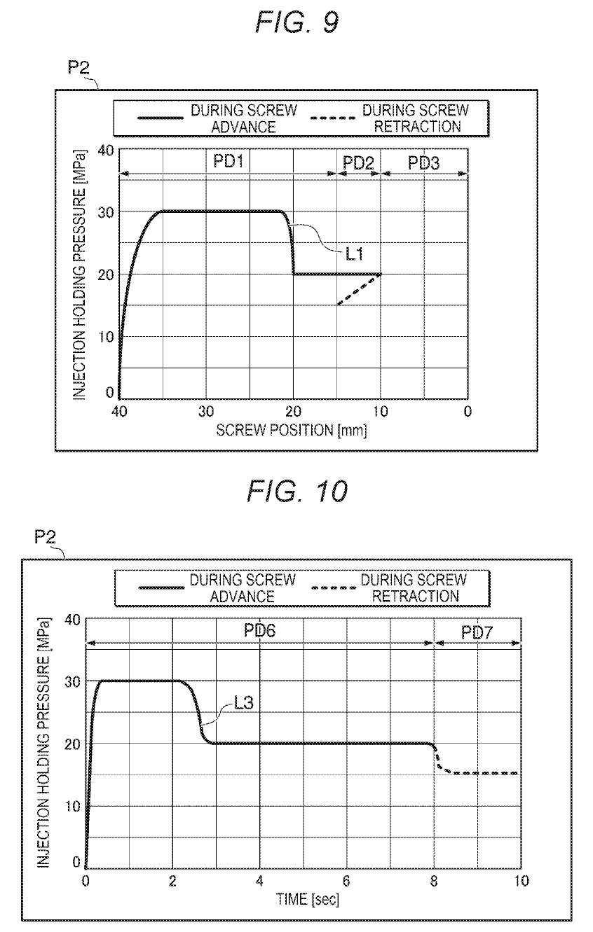

FIG. 9 is a diagram showing a fifth example of the waveform display image P2. A graph shown in FIG. 9 is the same as the graph shown in FIG. 5 except that the screw retraction information is not the display mode of the screw retraction section. In the example shown in FIG. 9, in the graph shown in FIG. 9, the information processing device X makes a line type of the screw retraction waveform among lines indicating the waveform L1, different from a line type of the screw non-retraction waveform among the lines indicating the waveform L1. Accordingly, the information processing device X can display the line type of the screw retraction waveform on the graph as the screw retraction information. As a result, in a graph of a waveform indicating the temporal change in the value of the target detection quantity, the information processing device X can make it possible for the user to easily specify the cycle in which the screw is retracted in the injection molding process, by the screw retraction waveform among the waveforms plotted on the graph.

Displaying the screw retraction information by the line type, as shown in FIG. 9, is possible even when the quantity indicated by the horizontal axis is set as the elapsed time in the target cycle. FIG. 10 is a diagram showing a sixth example of the waveform display image P2. A graph shown in FIG. 10 is the same as the graph shown in FIG. 8 except that the screw retraction information is not the display mode of the screw retraction section. In the example shown in FIG. 10, in the graph shown in FIG. 10, the information processing device X makes a line type of the screw retraction waveform among lines indicating the waveform L3, different from a line type of the screw non-retraction waveform among the lines indicating the waveform L3. Accordingly, the information processing device X can display the line type of the screw retraction waveform on the graph as the screw retraction information. As a result, in a graph of a waveform indicating the temporal change in the value of the target detection quantity, the information processing device X can make it possible for the user to easily specify the cycle in which the screw is retracted, by the screw retraction waveform among the waveforms plotted on the graph.

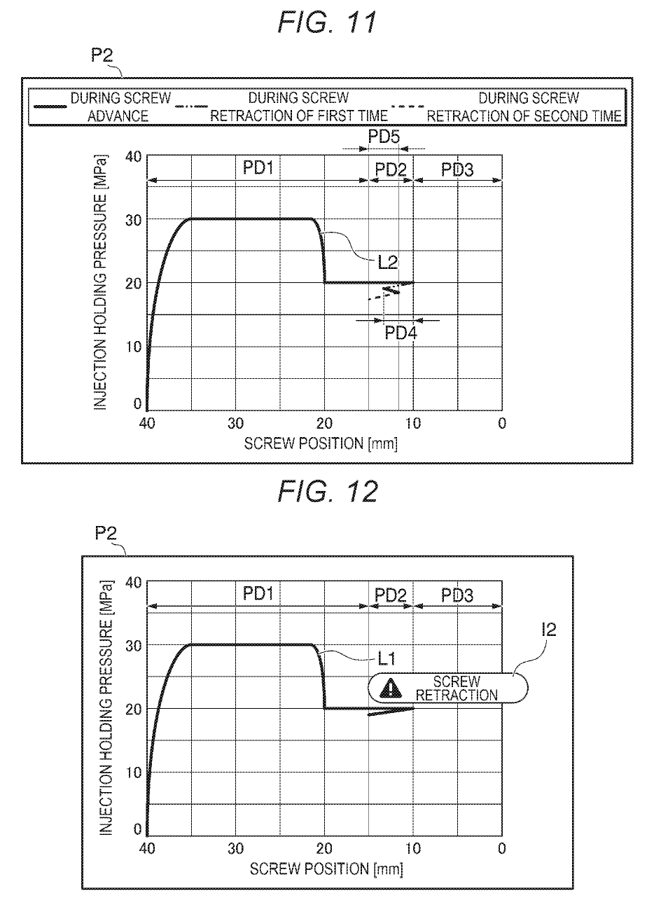

The information processing device X may be configured to, even when the screw is retracted N times or more in the injection molding process of the target cycle, make line types of the screw retraction waveforms each indicating the temporal change in the value of the target detection quantity when the screw is retracted in a corresponding one of the screw retraction sections for the retraction of the screw that occurs N times different on the graph of the waveform indicating the temporal change in the value of the injection holding pressure, as shown in FIG. 11. In this case, the information processing device X displays the screw retraction waveforms each indicating the temporal change in the value of the target detection quantity when the screw is retracted in a corresponding one of the screw retraction sections for the retraction of the screw that occurs N times, as the screw retraction information indicating the retraction of the screw that occurs N times.

FIG. 11 is a diagram showing a seventh example of the waveform display image P2. A graph shown in FIG. 11 is the same as the graph shown in FIG. 7 except that the screw retraction information is not the display mode of the screw retraction section. The waveform L2 shown in FIG. 11 has the same shape as the waveform L2 shown in FIG. 7. Therefore, in the waveform L2 shown in FIG. 11, the retraction of the screw also occurs twice in the section PD2. In FIG. 11, the information processing device X makes a line type of the screw retraction waveform in the section PD4 different from a line type of the screw retraction waveform in the section PD5. More specifically, in FIG. 11, the information processing device X sets the line type of the screw retraction waveform in the section PD4 to a two-dot chain line, and sets the line type of the screw retraction waveform in the section PD5 to a broken line. Accordingly, the information processing device X displays the line type of the screw retraction waveform in the section PD4 and the line type of the screw retraction waveform in the section PD5 as the screw retraction information indicating the retraction of the screw that occurs twice.

The screw retraction information as described above may be a mark displayed on the graph of the waveform indicating the temporal change in the value of the target detection quantity. In other words, the screw retraction information displayed on the graph may be a mark indicating that the screw is retracted in the injection molding process of the target cycle. FIG. 12 is a diagram showing an eighth example of the waveform display image P2. A graph shown in FIG. 12 is the same as the graph shown in FIG. 5 except that the shape of the plotted waveform L1 is different. In the waveform L1 shown in FIG. 12, in the section PD2, the value of the injection holding pressure when the screw is advanced and the value of the injection holding pressure when the screw is retracted are slightly different. Therefore, it can also be determined from the shape of the waveform L1 that the screw is retracted in the injection molding process of the target cycle. However, in the section PD2, when the value of the injection holding pressure when the screw is advanced and the value of the injection holding pressure when the screw is retracted are slightly different, the user may overlook that the screw is retracted in the section PD2. Therefore, as shown in FIG. 12, the information processing device X displays a mark I2 indicating that the screw is retracted in the section PD2, as the screw retraction information. The information processing device X may be configured to display the mark I2 on the graph, or may be configured to display the mark I2 separately from the graph. In the example shown in FIG. 12, the mark I2 is displayed on the graph.

Here, the mark I2 includes one or both of an icon indicating that the screw is retracted in the injection molding process of the target cycle and a message indicating that the screw is retracted in the injection molding process. In the example shown in FIG. 12, the mark I2 includes both the icon and the message. In this example, a design of the icon is the same as the design of the icon I1 shown in FIG. 4, but may be a design different from the design of the icon I1. In this example, the message is "screw retraction", which is merely an example, and may be another message. The mark I2 may be configured to indicate the section PD2 by a lead line, a balloon, an arrow indicating a width of the section PD2, or the like, or may be configured not to indicate the section PD2.

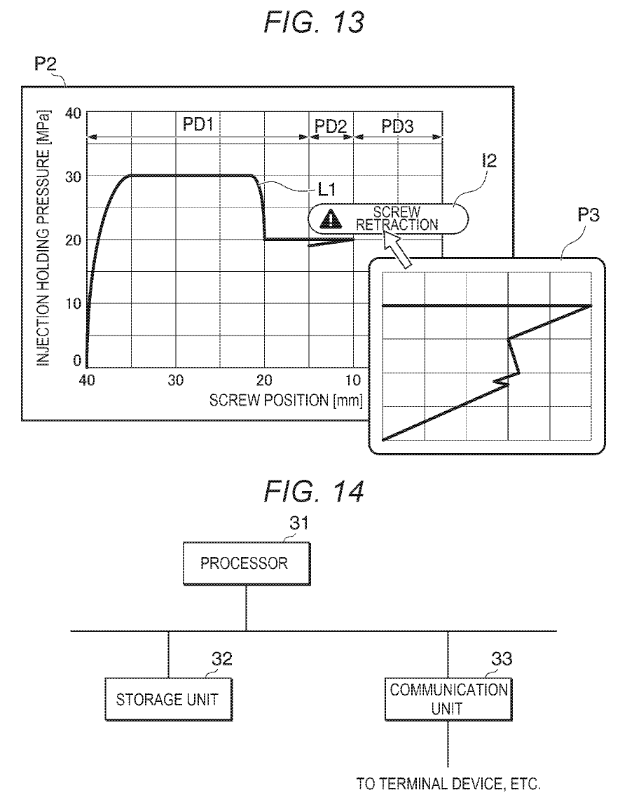

The information processing device X may be configured to, when an operation on the mark I2 is received, display, on the graph shown in FIG. 12, an enlarged image P3 obtained by enlarging a region including a line included in the section PD2, which is the screw retraction section, among the lines indicating the waveform L1 on the graph, as shown in FIG. 13. FIG. 13 is a diagram showing an example of a state in which the enlarged image P3 is displayed on the graph shown in FIG. 12. In the example shown in FIG. 13, the operation is a mouseover. Therefore, in FIG. 13, a cursor partially overlapping the mark I2 is shown.

Here, in the injection molding process of the target cycle, when the screw is retracted, a pressure on the screw often fluctuates a plurality of times. In such a case, in the waveform L1 shown in FIG. 12, it is difficult for the user to specify occurrence of a plurality of times of retraction of the screw corresponding to the plurality of times of fluctuations. Displaying the enlarged image P3 is an example of means for solving such a problem. In the example shown in FIG. 13, a waveform indicating three times of retraction of the screw is displayed in the enlarged image P3. Therefore, by displaying the enlarged image P3, the information processing device X can make it possible for the user to easily specify details of the retraction of the screw occurring in the target cycle.

### Hardware Configuration of Information Processing Device X

Here, the information processing device 20 and the server 30 may have the same hardware configuration or may have different hardware configurations. Hereinafter, as an example, a case in which the information processing device 20 and the server 30 have the same hardware configuration will be described. In other words, in one example, the information processing device X has a hardware configuration as shown in FIG. 14. FIG. 14 is a diagram showing an example of a hardware configuration of the information processing device X.

The information processing device X includes, for example, a processor 31, a storage unit 32, and a communication unit 33. These component elements are communicably connected to one another via a bus. The information processing device X communicates with other devices via the communication unit 33. For example, when the information processing device X is the information processing device 20, the other devices are the injection molding apparatus, the server 30, the terminal device 40, and the like. For example, when the information processing device X is the server 30, the other devices are the information processing device 20, the terminal device 40, and the like.

The processor 31 is, for example, a central processing unit (CPU). Instead of the CPU, the processor 31 may be another processor such as a field programmable gate array (FPGA). The processor 31 executes various programs stored in the storage unit 32.

The storage unit 32 is, for example, a storage device including a hard disk drive (HDD), a solid-state drive (SSD), an electrically erasable programmable read-only memory (EEPROM), a read-only memory (ROM), and a random access memory (RAM). Instead of being built in the information processing device X, the storage unit 32 may be an external storage device connected to a digital input and output port such as a universal serial bus (USB). The storage unit 32 stores various types of information, various images, and various programs to be processed by the information processing device X. That is, the various types of information stored in the information processing device X are stored in the storage unit 32.

The communication unit 33 is a communication device including, for example, a digital input and output port such as a USB, an Ethernet (registered trademark) port, and an antenna for wireless communication.

### Functional Configuration of Information Processing Device X

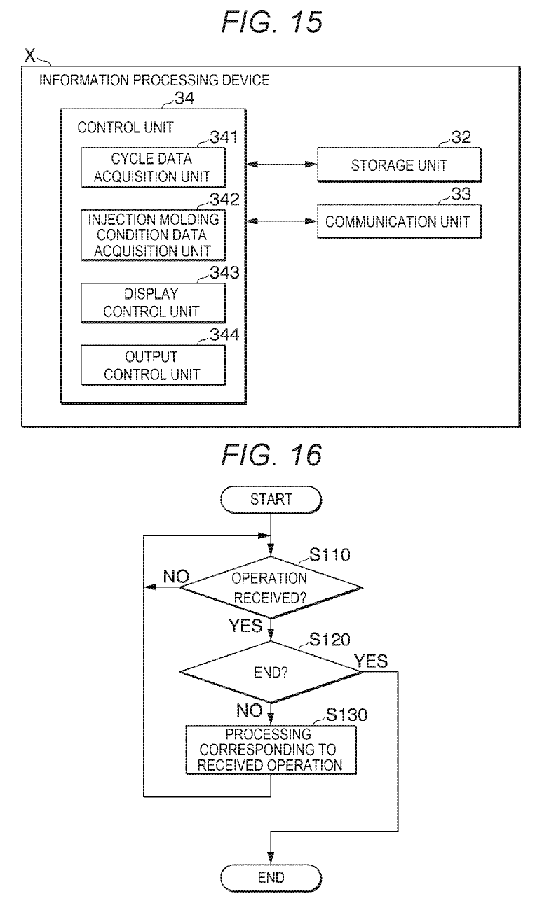

Here, the information processing device 20 and the server 30 may have the same functional configuration or may have different functional configurations. Hereinafter, as an example, a case in which the information processing device 20 and the server 30 have the same functional configuration will be described. In other words, in this example, the information processing device X has a functional configuration as shown in FIG. 15. FIG. 15 is a diagram showing an example of the functional configuration of the information processing device X.

The information processing device X includes the storage unit 32, the communication unit 33, and a control unit 34.

The control unit 34 controls the entire information processing device X. The control unit 34 includes at least a cycle data acquisition unit 341, an injection molding condition data acquisition unit 342, a display control unit 343, and an output control unit 344. These functional units provided in the control unit 34 are implemented by, for example, the processor 31 executing the various programs stored in the storage unit 32. A part or all of the functional units may be hardware functional units such as a large scale integration (LSI) or an application specific integrated circuit (ASIC).

The cycle data acquisition unit 341 acquires the cycle data for each cycle of each injection molding apparatus from a device communicably connected to the information processing device X. Examples of the device include the injection molding apparatus and the information processing device 20.

The injection molding condition data acquisition unit 342 acquires the injection molding condition data from a device communicably connected to the information processing device X every time the injection molding condition is set in each injection molding apparatus. Examples of the device include the injection molding apparatus and the information processing device 20.

The display control unit 343 generates various images in response to the received operation. For example, the display control unit 343 generates the search image P1. The display control unit 343 transmits the generated images to the terminal device 40 and displays the images on the terminal device 40.

The output control unit 344 outputs various types of data to another device in response to the received operation. For example, the output control unit 344 outputs the download data to another device in response to the operation received via the search image P1.

### Processing Performed by Information Processing Device X in Response to Received Operation

Referring to FIG. 16, processing performed by the information processing device X in response to each operation described above will be described. FIG. 16 is a diagram showing an example of a flow of the processing performed by the information processing device X in response to a received operation. Hereinafter, as an example, a case will be described in which the information processing device X is in a state in which various operations from the user can be received via the terminal device 40 at a timing before processing in step S110 shown in FIG. 16 is performed. Hereinafter, as an example, a case in which a plurality of pieces of cycle data and a plurality of pieces of injection molding condition data are already stored in the information processing device X at the timing will be described.

The control unit 34 waits until an operation is received via the terminal device 40 (step S110). In FIG. 16, the processing in step S110 is indicated by "operation received?".

When it is determined that the operation has been received via the terminal device 40 (step S110: YES), the control unit 34 determines whether the received operation is an operation for ending the processing in the flowchart shown in FIG. 16 (step S120). The determination processing may be performed by the control unit 34 in step S120 by a known method or by a method to be developed in the future. In FIG. 16, the processing in step S120 is indicated by "end?".

When it is determined that the operation received in step S110 is an operation for ending the processing in the flowchart shown in FIG. 16 (step S120: YES), for example, the control unit 34 ends the processing in the flowchart shown in FIG. 16.

On the other hand, when it is determined that the operation received in step S110 is not an operation for ending the processing in the flowchart shown in FIG. 16 (step S120: NO), the control unit 34 performs processing corresponding to the received operation (step S130). The processing includes various types of processing described as the processing performed by the information processing device X in the present embodiment. Here, since the processing performed by the control unit 34 in step S130 is already described with reference to FIGS. 3 to 13, a detailed description of the processing will be omitted.

After the processing in step S130 is performed, the control unit 34 transitions to step S110 and waits again until an operation is received via the terminal device 40.

By the processing as described above, when the screw is retracted in the injection molding process of a target cycle which is a cycle of the target cycle data among the cycle data, the information processing device displays, based on the screw position time-series information of the target cycle data, the screw retraction information indicating that the screw is retracted in the injection molding process of the target cycle. Accordingly, the information processing device X can make it possible to easily specify the cycle in which the retraction of the screw occurs.

The molding management system 1 described above may include the terminal device 40. The molding management system 1 described above may include an injection molding apparatus such as the injection molding apparatus 11.

The contents described above may be combined in any manner.

### Appendix

### [1]

A molding management system for managing production of a product in a production process including an injection molding process of the product performed by an injection molding apparatus, the molding management system including:

an information processing device communicably connected to a terminal device, in which

the injection molding apparatus includes an extrusion unit configured to extrude, in the injection molding process, a material used for injection molding of the product into a cavity in a mold attached to the injection molding apparatus, and

the information processing device

acquires cycle data from the injection molding apparatus for each cycle of performing injection molding, the cycle data including extrusion unit position time-series information indicating a time series of a position of the extrusion unit controlled by the injection molding apparatus in execution of the cycle, and

when the extrusion unit is retracted in the injection molding process of a first cycle which is the cycle of first cycle data among the cycle data, displays, on a display unit based on the extrusion unit position time-series information of the first cycle data, extrusion unit retraction information indicating that the extrusion unit is retracted in the injection molding process of the first cycle.

### [2]

The molding management system according to [1], in which

the information processing device

in response to a received operation, displays, on the display unit, a cycle data list image for displaying a list of the cycle data that is designated, and

when the first cycle data is included in the list and the extrusion unit is retracted in the injection molding process of the first cycle, displays an icon indicating that the extrusion unit is retracted in the injection molding process of the first cycle, as the extrusion unit retraction information at a position corresponding to the first cycle data included in the list among positions in the cycle data list image.

### [3]

The molding management system according to [1] or [2], in which

the cycle data includes, for each of a plurality of detection quantities controlled by the injection molding apparatus in execution of the cycle, time-series information indicating a time series of a corresponding one of the detection quantities,

the position of the extrusion unit is one of the plurality of detection quantities,

the extrusion unit position time-series information is one piece of the time-series information for the detection quantities, and

the information processing device

in response to a received operation, displays, on the display unit based on the time-series information indicating a time series of a target detection quantity designated among the plurality of detection quantities included in the first cycle data, a waveform display image for displaying a graph of a waveform indicating a temporal change in the target detection quantity, and

displays the extrusion unit retraction information on the graph when the extrusion unit is retracted in the injection molding process of the first cycle.

### [4]

The molding management system according to [3], in which

when displaying the extrusion unit retraction information on the graph, the information processing device displays, as the extrusion unit retraction information, information indicating an extrusion unit retraction section in which the extrusion unit is retracted in the injection molding process among sections on the graph.

### [5]

The molding management system according to [4], in which

on the graph, the information processing device displays a display mode of the extrusion unit retraction section as the extrusion unit retraction information by making the display mode of the extrusion unit retraction section different from a display mode of an extrusion unit non-retraction section other than the extrusion unit retraction section.

### [6]

The molding management system according to [5], in which

when the extrusion unit is retracted N times or more in the injection molding process of the first cycle, the information processing device displays, on the graph, display modes of the respective extrusion unit retraction sections for the retraction of the extrusion unit that occurs N times as the extrusion unit retraction information indicating the retraction of the extrusion unit that occurs N times, by making the display modes of the respective extrusion unit retraction sections for the retraction of the extrusion unit that occurs N times different, N being an integer of 2 or more.

### [7]

The molding management system according to [4], in which

the extrusion unit retraction information displayed on the graph is a mark indicating that the extrusion unit is retracted in the injection molding process.

### [8]

The molding management system according to [7], in which

the mark includes one or both of an icon indicating that the extrusion unit is retracted in the injection molding process and a message indicating that the extrusion unit is retracted in the injection molding process.

### [9]

The molding management system according to [7] or [8], in which

when an operation on the mark is received, the information processing device displays, on the graph, an enlarged image obtained by enlarging a region including a line included in the extrusion unit retraction section among lines indicating the waveform on the graph.

### [10]

The molding management system according to [4], in which

the information processing device displays, on the graph, a line type of a line indicating a temporal change in a value of the target detection quantity when the extrusion unit is retracted in the extrusion unit retraction section among lines indicating the waveform on the graph as the extrusion unit retraction information, by making the line type of the line indicating the temporal change in the value of the target detection quantity when the extrusion unit is retracted in the extrusion unit retraction section among the lines indicating the waveform on the graph different from a line type of a line indicating a temporal change in the value of the target detection quantity when the extrusion unit is not retracted among the lines indicating the waveform on the graph.

### [11]

The molding management system according to [10], in which

when the extrusion unit is retracted N times or more in the injection molding process of the first cycle, the information processing device displays, on the graph, line types of lines each indicating the temporal change in the value of the target detection quantity when the extrusion unit is retracted in a corresponding one of the extrusion unit retraction sections for the retraction of the extrusion unit that occurs N times among the lines indicating the waveform on the graph as the extrusion unit retraction information indicating the retraction of the extrusion unit that occurs N times, by making the line types of the lines each indicating the temporal change in the value of the target detection quantity when the extrusion unit is retracted in the corresponding one of the extrusion unit retraction sections for the retraction of the extrusion unit that occurs N times among the lines indicating the waveform on the graph different, N being an integer of 2 or more.

### [12]

The molding management system according to any one of [3] to [11], in which

the information processing device switches a quantity indicated by a horizontal axis of the graph to either an elapsed time in the first cycle or a position of the extrusion unit in the first cycle, in response to a received operation.

### [13]

The molding management system according to any one of [1] to [12], further including:

the terminal device.

### [14]

The molding management system according to any one of [1] to [13], further including:

the injection molding apparatus.

The embodiment of the present disclosure is described in detail above with reference to the drawings. However, a specific configuration is not limited to the embodiment and may be, for example, changed, replaced, or deleted without departing from the gist of the present disclosure.

A program for implementing a function of any component in the device described above may be recorded in a computer-readable recording medium and the program may be read and executed by a computer system. Here, the device is, for example, the injection molding apparatus 11, the information processing device 20, the server 30, or the terminal device 40. Here, the "computer system" referred to here includes an operating system (OS) and hardware such as peripheral devices. The "computer-readable recording medium" refers to a portable medium such as a flexible disc, a magneto-optical disc, a ROM, or a compact disk (CD) ROM or a storage device such as a hard disk built in the computer system. Further, the "computer-readable recording medium" includes a medium that stores the program for a certain period of time, such as a volatile memory inside the computer system serving as a server or a client when the program is transmitted via a network such as the Internet or a communication line such as a telephone line.

The program may be transmitted from a computer system in which the program is stored in a storage device or the like to another computer system via a transmission medium or by a transmission wave in the transmission medium. Here, the "transmission medium" for transmitting the program refers to a medium having a function of transmitting information like a network such as the Internet or a communication line such as a telephone line.

The program may be a program for implementing a part of the functions described above. Further, the program may be a so-called differential file or differential program that can implement the functions described above in combination with a program already recorded in the computer system.

What is claimed is:

1. A molding management system for managing production of a product in a production process including an injection molding process of the product performed by an injection molding apparatus, the molding management system comprising:
an information processing device communicably connected to a terminal device, wherein
the injection molding apparatus includes an extrusion unit configured to extrude, in the injection molding process, a material used for injection molding of the product into a cavity in a mold attached to the injection molding apparatus, and
the information processing device
acquires cycle data from the injection molding apparatus for each cycle of performing injection molding, the cycle data including extrusion unit position time-series information indicating a time series of a position of the extrusion unit controlled by the injection molding apparatus in execution of the cycle, and
when the extrusion unit is retracted in the injection molding process of a first cycle which is the cycle of first cycle data among the cycle data, displays, on a display unit based on the extrusion unit position time-series information of the first cycle data, extrusion unit retraction information indicating that the extrusion unit is retracted in the injection molding process of the first cycle.

2. The molding management system according to claim 1, wherein
the information processing device
in response to a received operation, displays, on the display unit, a cycle data list image for displaying a list of the cycle data that is designated, and
when the first cycle data is included in the list and the extrusion unit is retracted in the injection molding process of the first cycle, displays an icon indicating that the extrusion unit is retracted in the injection molding process of the first cycle, as the extrusion unit retraction information at a position corresponding to the first cycle data included in the list among positions in the cycle data list image.

3. The molding management system according to claim 1, wherein
the cycle data includes, for each of a plurality of detection quantities controlled by the injection molding apparatus in execution of the cycle, time-series information indicating a time series of a corresponding one of the detection quantities,
the position of the extrusion unit is one of the plurality of detection quantities,
the extrusion unit position time-series information is one piece of the time-series information for the detection quantities, and
the information processing device
in response to a received operation, displays, on the display unit based on the time-series information indicating a time series of a target detection quantity designated among the plurality of detection quantities included in the first cycle data, a waveform display image for displaying a graph of a waveform indicating a temporal change in the target detection quantity, and
displays the extrusion unit retraction information on the graph when the extrusion unit is retracted in the injection molding process of the first cycle.

4. The molding management system according to claim 3, wherein
when displaying the extrusion unit retraction information on the graph, the information processing device displays, as the extrusion unit retraction information, information indicating an extrusion unit retraction section in which the extrusion unit is retracted in the injection molding process among sections on the graph.

5. The molding management system according to claim 4, wherein
on the graph, the information processing device displays a display mode of the extrusion unit retraction section as the extrusion unit retraction information by making the display mode of the extrusion unit retraction section different from a display mode of an extrusion unit non-retraction section other than the extrusion unit retraction section.

6. The molding management system according to claim 5, wherein
when the extrusion unit is retracted N times or more in the injection molding process of the first cycle, the information processing device displays, on the graph, display modes of the respective extrusion unit retraction sections for the retraction of the extrusion unit that occurs N times as the extrusion unit retraction information indicating the retraction of the extrusion unit that occurs N times, by making the display modes of the respective extrusion unit retraction sections for the retraction of the extrusion unit that occurs N times different, N being an integer of 2 or more.

7. The molding management system according to claim 4, wherein
the extrusion unit retraction information displayed on the graph is a mark indicating that the extrusion unit is retracted in the injection molding process.

8. The molding management system according to claim 7, wherein
the mark includes one or both of an icon indicating that the extrusion unit is retracted in the injection molding process and a message indicating that the extrusion unit is retracted in the injection molding process.

9. The molding management system according to claim 7, wherein
when an operation on the mark is received, the information processing device displays, on the graph, an enlarged image obtained by enlarging a region including a line included in the extrusion unit retraction section among lines indicating the waveform on the graph.

10. The molding management system according to claim 4, wherein
the information processing device displays, on the graph, a line type of a line indicating a temporal change in a value of the target detection quantity when the extrusion unit is retracted in the extrusion unit retraction section among lines indicating the waveform on the graph as the extrusion unit retraction information, by making the line type of the line indicating the temporal change in the value of the target detection quantity when the extrusion unit is retracted in the extrusion unit retraction section among the lines indicating the waveform on the graph different from a line type of a line indicating a temporal change in the value of the target detection quantity when the extrusion unit is not retracted among the lines indicating the waveform on the graph.

11. The molding management system according to claim 10, wherein
when the extrusion unit is retracted N times or more in the injection molding process of the first cycle, the information processing device displays, on the graph, line types of lines each indicating the temporal change in the value of the target detection quantity when the extrusion unit is retracted in a corresponding one of the extrusion unit retraction sections for the retraction of the extrusion unit that occurs N times among the lines indicating the waveform on the graph as the extrusion unit retraction information indicating the retraction of the extrusion unit that occurs N times, by making the line types of the lines each indicating the temporal change in the value of the target detection quantity when the extrusion unit is retracted in the corresponding one of the extrusion unit retraction sections for the retraction of the extrusion unit that occurs N times among the lines indicating the waveform on the graph different, N being an integer of 2 or more.

12. The molding management system according to claim 3, wherein
the information processing device switches a quantity indicated by a horizontal axis of the graph to either an elapsed time in the first cycle or a position of the extrusion unit in the first cycle, in response to a received operation.

13. The molding management system according to claim 1, further comprising:
the terminal device.

14. The molding management system according to claim 1, further comprising:
the injection molding apparatus.
